(19) United States
(12) Patent Application Publication
(10) Pub. No.: US 2018/0345302 A1
(43) Pub. Date: Dec. 6, 2018

(54) DISPENSING NOZZLE

(71) Applicant: Deere & Company, Moline, IL (US)

(72) Inventors: Ali Tayh, Bettendorf, IA (US); Nathan Tortorella, Bettendorf, IA (US); Ryan M. Gneiting, Bettendorf, IA (US); Jared Morrison, La Porte City, IA (US); Thomas M. Campen, Davenport, IA (US); Daniel J. Cox, Davenport, IA (US)

(21) Appl. No.: 15/612,448

(22) Filed: Jun. 2, 2017

(51) Int. Cl. B05B 1/30; B05B 1/34; B65D 43/02; B65D 47/08

(52) U.S. Cl. CPC B05B 1/3013; B65D 47/0838; B65D 43/0212; B05B 1/34

(57) ABSTRACT

A dispensing nozzle is disclosed herein. The dispensing nozzle includes a hollow enclosure defining an inner chamber. A fluid dispersion element is arranged within the inner chamber and includes a fluid inlet having at least two orifices that respectively open into and communicate with an associated fluid dispersion channel. Each fluid dispersion channel has a reduced cross section from that of the fluid inlet and are arranged to disperse flow of materials received at the fluid inlet into parallel streams of flow prior to recombination of the materials at the nozzle outlet.

### TECHNICAL FIELD

The present disclosure generally relates to dispensing apparatuses, and, more particularly to a dispensing nozzle having a fluid dispersion element for dispensing viscous materials.

### BACKGROUND

In industrial and manufacturing processes, the use of dispensing apparatuses for applying materials such as adhesives, sealants, and greases to product surfaces are well known in the art. For example, in drive train and engine manufacturing applications, dispensing apparatuses may be used to apply sealants and adhesives to various assembly parts. For example, such applications require controlled and accurate dispensing to ensure continuous skip-free application of the materials. During manufacturing and packaging, however, materials are packaged in such a manner that air bubbles become trapped, thereby inhibiting the flow of material as it is dispensed. This in turn can cause skips in a continuously dispensed bead, which can result in leakage through an open flow path.

To address such concerns, some conventional approaches utilize vacuum and/or vibrational techniques to reduce air bubble formation. Such techniques, however, require purging in order to remove excess materials, which leads to increased costs and manufacturing times. In other conventional approaches, the use of rotational nozzles that mechanically rotate as the adhesive is being dispensed have been employed. Similar to vacuum techniques, this approach is also cost ineffective due to increased costs associated with expensive material and equipment use.

To overcome such drawbacks, other approaches have employed the use of paint rollers to apply sealant and other materials to flanges. With the use of paint rollers, dispensing accuracy and product quality is decreased. For example, during application, excess material may leak into ports or grooves, thereby causing increased wear and degradation over time, as well as uncontrolled material flow. As such, there is a need in the art for a dispensing apparatus that is cost effective, improves product quality, increases repeatability, and increases the dispensing efficiency and accuracy of medium and high viscosity materials.

### SUMMARY

In accordance with one embodiment, dispensing nozzle includes a hollow enclosure defining an inner chamber is provided. A fluid dispersion element is arranged within the inner chamber and includes a fluid inlet having at least two orifices that respectively open into and communicate with an associated fluid dispersion channel. Each fluid dispersion channel has a cross section that is reduced in sized from that of the fluid inlet. The fluid dispersion channels are arranged to disperse flow of materials received at the fluid inlet into parallel streams of flow prior to recombination of the materials at the nozzle outlet.

### BRIEF DESCRIPTION OF THE DRAWINGS

FIG. 1 is an expanded side view of a dispensing apparatus according to an embodiment;

FIG. 2A is a side view of a dispensing nozzle of the dispensing apparatus of FIG. 1 according to an embodiment;

FIG. 2B is a perspective view of the dispensing nozzle of the dispensing apparatus of FIG. 1 according to an embodiment;

FIG. 2C is a rear view of the dispensing nozzle of the dispensing apparatus of FIG. 1 according to an embodiment;

FIG. 2D is a front view of the dispensing nozzle of the dispensing apparatus of FIG. 1 according to an embodiment;

front view of a dispensing nozzle of the dispensing apparatus of FIG. 1 according to an embodiment;

FIG. 3A is a side cross-sectional view of the dispensing nozzle of the dispensing apparatus of FIG. 1 illustrating a single fluid dispersion channel according to an embodiment;

FIG. 3B is a side cross-sectional view of the dispensing nozzle of the dispensing apparatus of FIG. 1 illustrating two fluid dispersion channels according to an embodiment;

FIG. 3C is a perspective cross-sectional view of the dispensing nozzle of the dispensing apparatus of FIG. 1 according to an embodiment;

FIG. 4A is a perspective cross-sectional view of a dispensing nozzle and stopper of the dispensing apparatus of FIG. 1 according to an embodiment;

FIG. 4B is a perspective cross-sectional view of a dispensing nozzle and stopper of the dispensing apparatus of FIG. 1 according to an embodiment;

FIG. 5A is a side view of a dispensing nozzle of the dispensing apparatus of FIG. 1 according to an embodiment;

FIG. 5B is a side view of a dispensing nozzle of the dispensing apparatus of FIG. 1 according to an embodiment; and

FIG. 6 is a flow diagram of a method for fabricating the dispensing nozzle of FIG. 1.

Like reference numerals are used to indicate like elements throughout the several figures.

### DETAILED DESCRIPTION

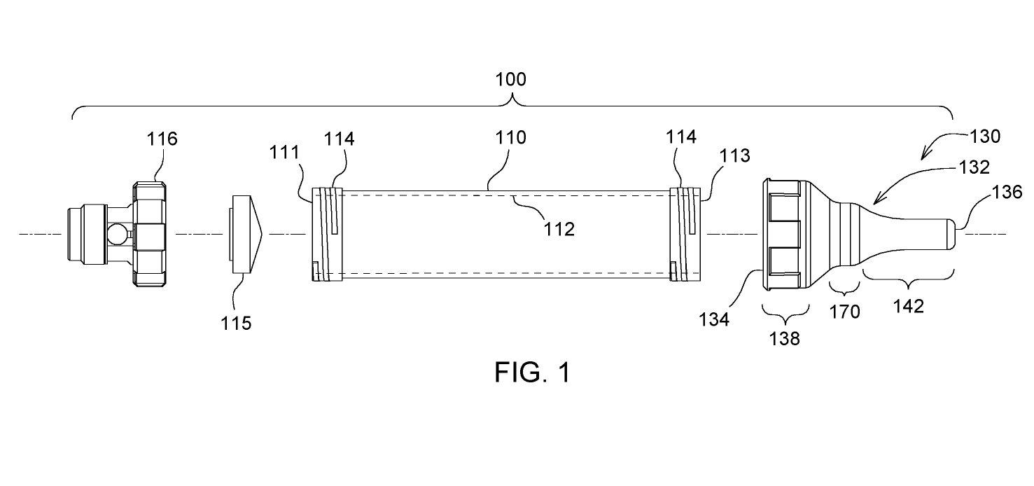

Referring to FIG. 1, an exemplary dispensing apparatus 100 is shown. The dispensing apparatus 100 is of conventional form and is designed for use in a variety of industrial applications, e.g., engines and/or drive assemblies, to dispense viscous materials such as adhesives, sealants, and oil-based liquids. As depicted in FIG. 1, the dispensing apparatus 100 can comprise a tubular cartridge 110, which is sized to retain a volume of material within an internal reservoir 112 (FIG. 1), removably coupled at a first end 111 to an end cap 116 and at a second end 113 to a dispensing nozzle 130. The tubular cartridge 110 can comprise an external threaded member 114 arranged at opposing ends of the tubular cartridge 110 that allows for the tubular cartridge 110 to be matingly engaged with a corresponding coupling feature of the end cap 116 and dispensing nozzle 130. A plunger 115 is interposed between the end cap 116 and the first end 111 of the tubular cartridge 110 and is sized for removable insertion into at least a portion of the internal reservoir 112. For example, the plunger 115 is configured to move in a forward and rearward axial direction in and out of the internal reservoir 112 as material is dispensed from the tubular cartridge 110.

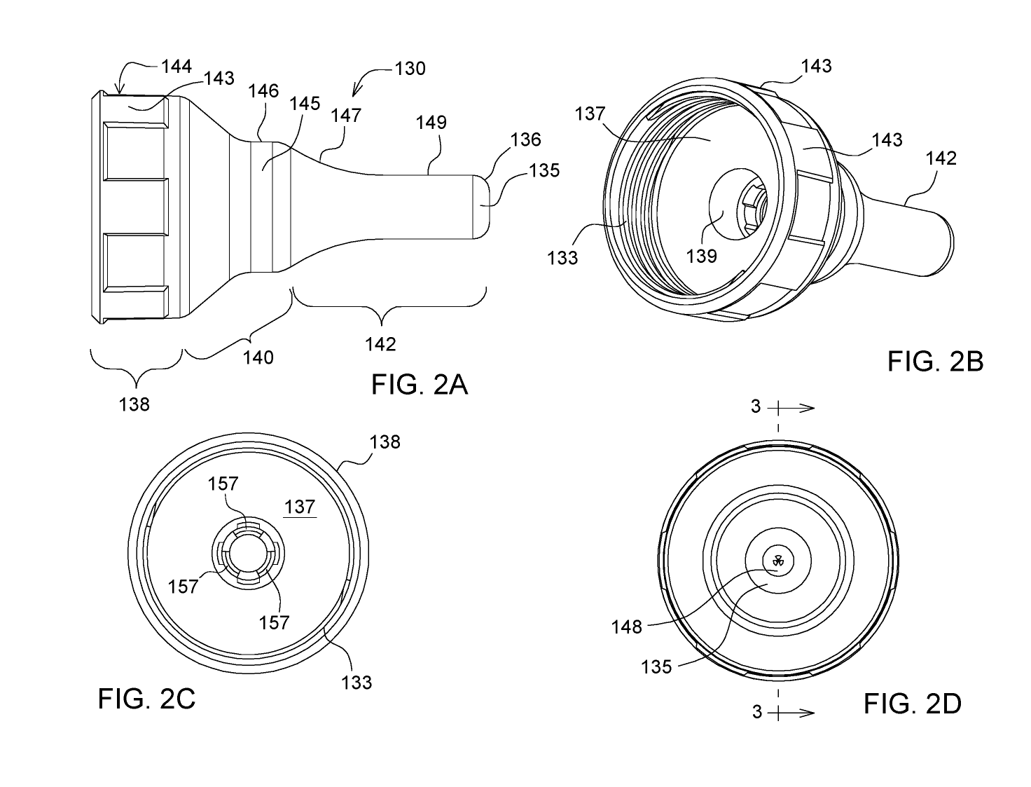

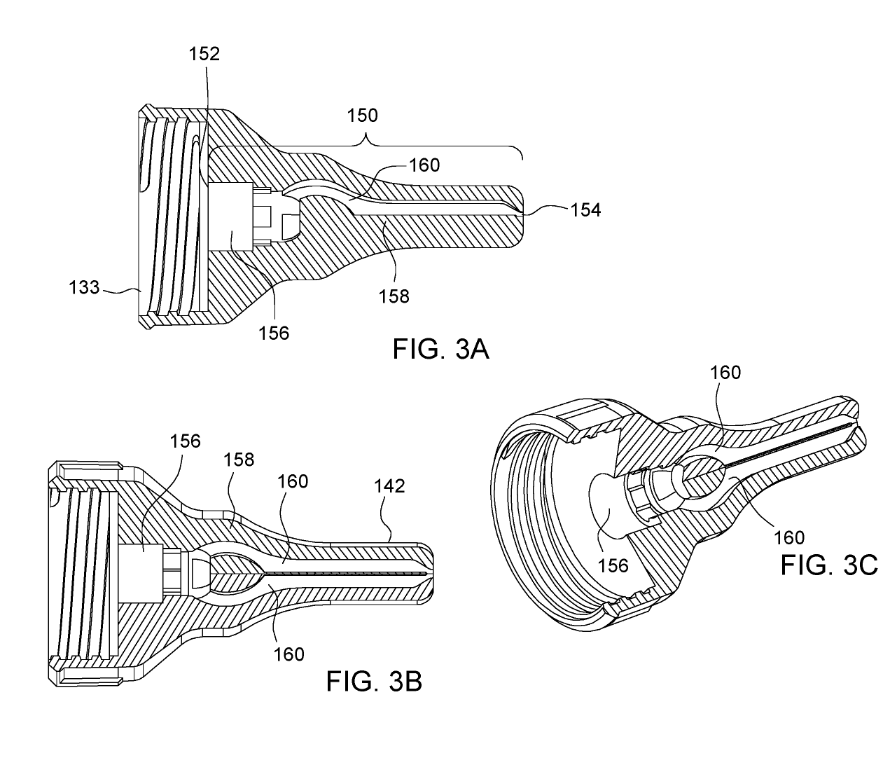

The dispensing nozzle 130 comprises a nozzle body 132, which, in some embodiments, includes a generally tapered configuration that gradually tapers inward and decreases in diameter from a nozzle inlet 134 to a nozzle outlet 136. The nozzle body 132 can comprise a collar 138 integrally formed (i.e., molded or machined as a single piece) with an intermediate portion 140 and a dispensing portion 142 as will be discussed in further detail with reference to FIGS. 2A-3C. In some embodiments, the collar 138 may comprise a gripping structure 144 arranged to circumferentially encompass an outer surface of the collar 138. The gripping structure 144 may comprise a plurality of substantially U-shaped grooves or indentations 143 to increase grip friction between the dispensing nozzle 130 and a user's hand. It should be noted, however, that the structural arrangement of the gripping structure 144 can and will vary in embodiments. For example, in some embodiments, the gripping structure 144 may comprise a single indentation or other rib-like or concave structure which is sized to accommodate a portion of a user's finger.

The intermediate portion 140 may comprise an annular member 146 having an outer ribbed surface 145. As depicted, the diameter of the intermediate portion 140 is smaller in size than that of the collar 138, which allows for a decreased volume of material to be channeled into the dispensing portion 142. The dispensing portion 142 extends outwardly and away from the nozzle body 132. For example, as depicted in FIG. 1, the dispensing portion 142 can be arranged to taper inwardly from an expanded portion 147, which has a cross-sectional area that is substantially similar as that of intermediate portion 140, to a narrower portion 149. At least one dispensing aperture 148 (FIGS. 2D and 3C) can be formed in a tip portion 165 of the nozzle outlet 136 for dispensing the viscous materials. In various embodiments, the size and dimensions of the dispensing aperture may vary according to design and/or specification requirements. Further, to improve product safety, the tip portion 165 may be rounded as illustrated in FIGS. 1, 2A, and 2B.

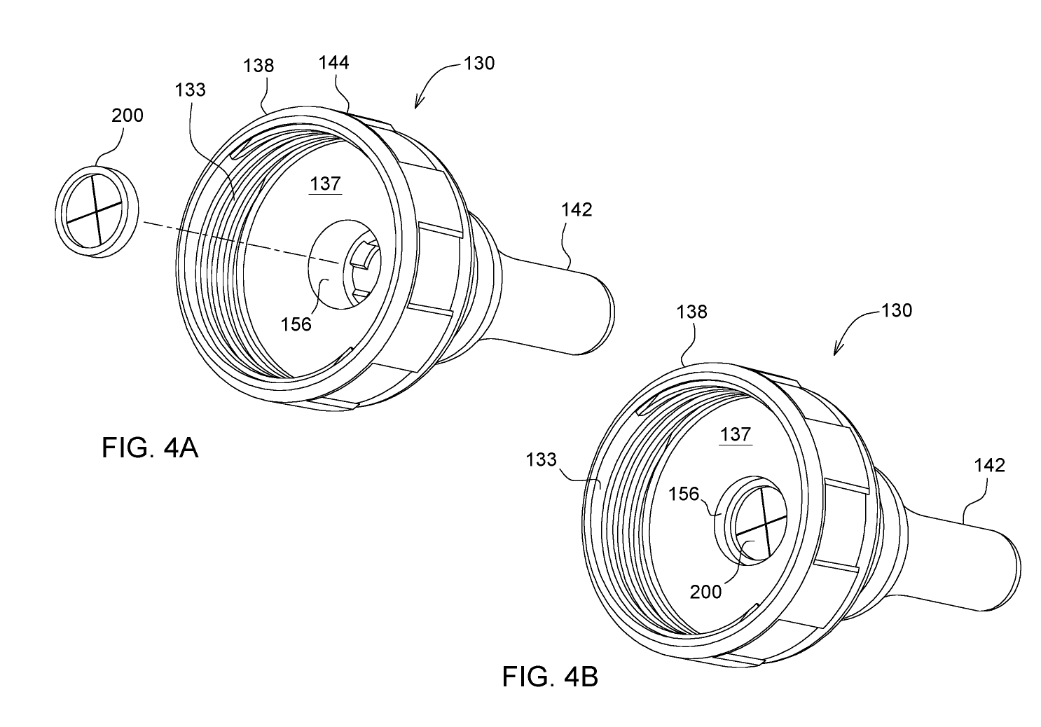

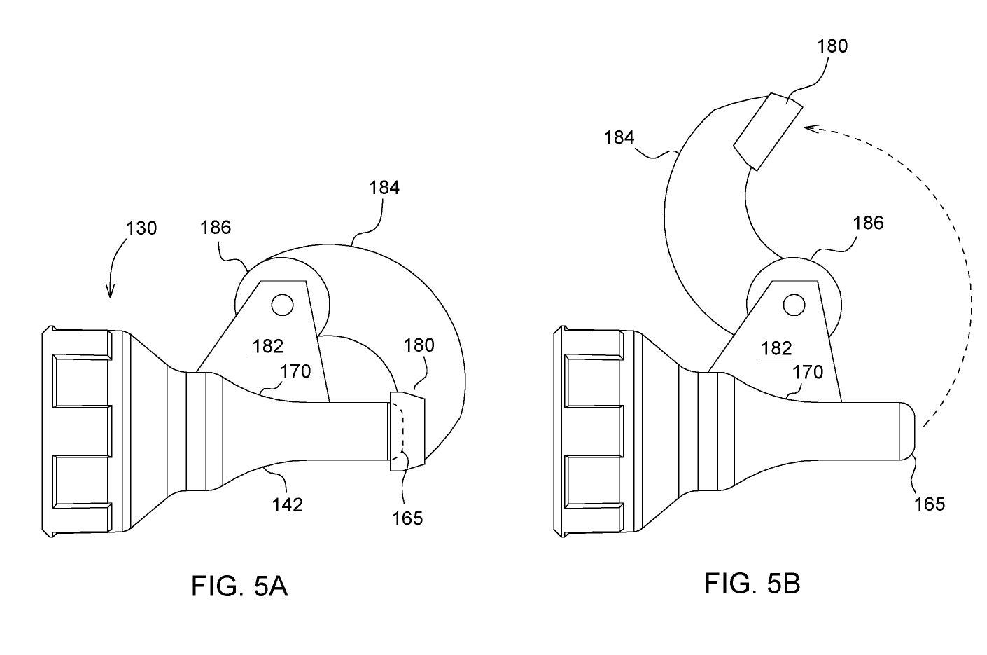

As will be appreciated by those skilled in the art, FIG. 1 is merely for illustrative and exemplary purposes and is in no way intended to limit the present disclosure or its applications. The dispensing nozzle 130 of the present disclosure can be adapted for use with a variety of dispensing apparatuses and, therefore, the arrangement and structural layout of the dispensing nozzle 130 can and will vary in embodiments. For example, in some embodiments, such as that discussed with reference to FIGS. 4A-5B, the dispensing nozzle 130 may comprise additional components such as a valve or tip cover to provide improved flow control.

Referring to FIGS. 2A-3C, a more detailed illustration of the dispensing nozzle 130 as discussed with reference to FIG. 1 is shown. The dispensing nozzle 130 may comprise an internal threaded member 133 annularly disposed around an inner surface of the collar 138 that is configured to matingly engage with at least one of the external threaded members 114 of the tubular cartridge 110. Such an arrangement is particularly advantageous in that it provides easy and rapid coupling and decoupling (i.e., quick connect capability for fast cartridge changes) of the collar 138 to and from the tubular cartridge 110, and allows for a variety of different sized and shaped cartridges to be used. Additionally, such an arrangement aligns and holds the tubular cartridge 100 within a cartridge housing (not shown) to allow for repeatable dispensing once a cartridge is changed.

In some embodiments, the internal threaded member 133 may also be configured to similarly engage with a corresponding coupling mechanism of a dispense gun housing (not shown) in which the tubular cartridge 110 arranged. As illustrated in FIG. 2B, in embodiments, the internal threaded member 133 terminates in a planar base surface 137 having an opening 139 formed, which permits passage of the viscous materials from the tubular cartridge 110 into a material feed chamber 150.

The material feed chamber 150 can be arranged to extend between a passage inlet 152 and a passage outlet 154. An inlet port 156 arranged in fluid communication with a fluid dispersion element 158 can be positioned at the passage inlet 152. The inlet port 156 can comprise a generally tubular configuration and may be sized such that it restricts a volume of material flow as material is dispensed from the tubular cartridge 110 to the dispensing nozzle 130. A plurality of channel openings 157 may be arranged within the inlet port 156, each of which opens into a respective feed channel of the fluid dispersion element 158. As depicted, the fluid dispersion element 158 can comprise at least two fluid dispersion channels 160 each having a first channel element 161a integrally formed with a second channel element 161b that is arranged to extend lengthwise through the dispensing portion 142. In some embodiments, the first channel element 161a can comprise a generally arcuate configuration and the second channel element 161b can comprise a generally linear configuration as illustrated in embodiments herein. In other embodiments, both the first and second channel elements 161a and 161b may comprise generally arcuate or other suitable configurations.

In embodiments, each of the fluid dispersion channels 160 can comprise a generally triangular cross section, but may vary according to design and/or specification requirements. For example, the shape, dimensions, and geometry of the fluid dispersion channels 160 will depend on a variety of variables, such as liquid composition, bubble concentration, temperature, pressure, and nozzle material (i.e., a cross-section of each fluid dispersion channel can be geometrically dimensioned based on a process variable). Additionally, although in FIGS. 2A-3C each fluid dispersion channel 160 is shown as having length dimensions substantially similar to the dispensing portion 142, it should be noted that FIGS. 2A-3C are not drawn to scale and that the size and dimensions of each fluid dispersion channel 160 may vary based on material properties or processing conditions.

As illustrated in FIGS. 3B and 3C, each fluid dispersion channel 160 can comprise an end portion 163 arranged at an outlet of the second channel element 161b. In some embodiments, the end portion 163 may comprise a slanted configuration such that a forward end 167 of a first fluid dispersion channel 160 is arranged proximate a forward end 167 of a second fluid dispersion channel 160 to facilitate material recombination as the materials exits the dispensing nozzle 130. For example, in use, as the materials (e.g., Loctite 5127, also known as Loctite 17430) are pushed out of the tubular cartridge 110 via plunger 115, it enters the dispensing nozzle 130 through the inlet port 156 as a single stream (i.e., first stream) before being divided into multiple streams (i.e., second streams) as it enters channel openings 157 and each of the fluid dispersion channels 160. Such an arrangement provides for increased flow rates and faster throughputs by allowing a larger number of small bubbles to be dispersed into the higher viscosity materials. Additionally, the nozzle design facilitates dispersion of air bubbles formed in each of the first and second streams to provide improved dispensing repeatability, efficiency, and accuracy, and resolves the need for purging. Further, with the present disclosure, as the bubbles are dispersed into the materials, audio indications of the bubble consolidations are provided to users to notify the users of the dispersion.

Referring to FIGS. 4A-4B, in other embodiments, the dispensing nozzle 130 may further comprise a valve 200 or other suitable flow control device to provide improved flow control. In some embodiments, the valve 200 may comprise an elastomeric valve having a generally circular configuration that is sized for removable insertion into the inlet port 156. Upon insertion, positioning and placement of the valve 200 can be secured by interposing the valve 200 between the dispensing nozzle 130 and the tubular cartridge 110. Although an elastomeric valve is disclosed herein, it should be noted that other suitable flow control devices may be used. For example, in other embodiments, the valve 200 may comprise a mechanical poppet, a needle, “snuff-bak” valve, or other suitable flow control elements.

Referring to FIGS. 5A-5B, in some embodiments, dispensing nozzle 130 may further comprise a cover 180 that is sized to enclose the tip portion 165 of the dispensing nozzle 130 to prevent inadvertent dripping of the dispensed materials. The cover 180 may be pivotally mounted to the dispensing nozzle 130 via a bracket member 182. The bracket member 182 can be configured for removable or fixed coupling to a mount surface 170 of the dispensing nozzle 130 in various embodiments. For example, in some embodiments, the bracket member 182 may be configured for slidable or snap engagement with a corresponding coupling feature arranged on the mount surface 170 of the dispensing nozzle 130.

As depicted, the cover 180 may comprise a support arm 184 having a generally arcuate configuration that is coupled to a hinge element 186 of the bracket member 182. Such an arrangement allows for pivotal movement of the support arm 184 about a pivot axis 185 arranged substantially perpendicular to an x-y planar surface of the bracket member 182. In various embodiments, the pivotal movement of the support arm 184 may be manually or automatically initiated. For example, in some embodiments, the cover 180 may comprise a pneumatically-activated cap such that placement and removal of the cover 180 to and from the dispensing nozzle 130 is automatically actuated using pneumatic or other suitable actuation devices.

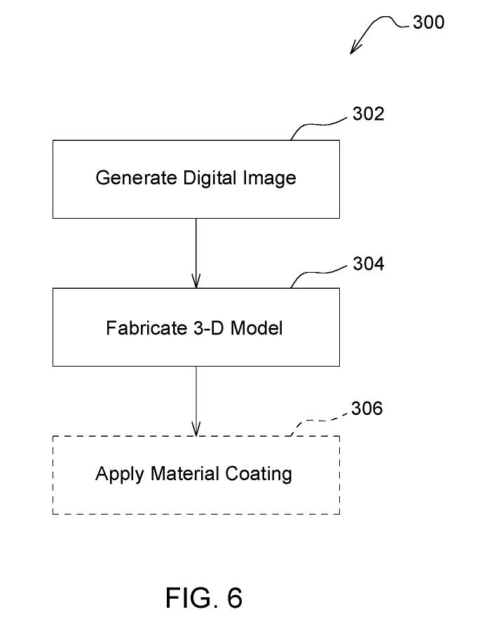

In FIG. 6, a flow diagram of a method 300 for manufacturing the dispensing nozzle 130 using three-dimensional (3-D) printing is shown. In embodiments, the dispensing nozzle 130 may be fabricated as a single 3-D printed part or a multi-part assembly. At 302, a 3-D digital image of the dispensing nozzle 130 is generated by an image processor utilizing various modeling techniques, such as, for example, primitive modeling, polygonal modeling, sub-division modeling, surface modeling, or other suitable modeling techniques. Next at 304, the digital image is sent to a processing device such as a 3-D printer or a similar prototyping machine that is capable of processing the digital image to generate a 3-D model of the dispensing nozzle 130. For example, once the digital image is received by the processing device, at 304, the 3-D model of the dispensing nozzle 130 can be fabricated utilizing an additive manufacturing process, which may include, but is not limited to, fused deposition, selective laser sintering, or fusion additive manufacturing.

As the model is fabricated, it should be noted that it is particularly advantageous to design the internal and external contours of the surface walls of the dispensing nozzle 130 such that the angular dimensions are approximately 90 degrees or less. In other words, the dispensing nozzle 130 is designed such that the angular curvature of the surface walls (e.g., outer and inner surface walls of the nozzle body 132, gripping structure 144, dispensing portion 142, fluid dispersion channels 160, etc.) does not exceed 90 degrees. This, in turn, allows for the dispensing nozzle 130 to be printed without the use of support material, additional process steps, or utilizing traditional processing techniques. For example, by utilizing rough 3-D printed models (i.e., without support materials), an air boundary layer is created at the surface walls which helps to increase the flow rate of the materials passing through the fluid dispersion channels 160.

In some embodiments, once the dispensing nozzle 130 is fabricated, the nozzle may be coated or treated with a material containing silicone or polytetrafluoroethylene to render the nozzle inert and to aid in the flow of sealant by reducing surface tension at 306. In other embodiments, the dispensing nozzle 130 may undergo further post treatment processes, wherein other materials (e.g., polyolefins) are deposited onto the nozzle utilizing processing techniques such as chemical vapor deposition or atmospheric pressure plasma deposition.

Without in any way limiting the scope, interpretation, or application of the claims appearing below, a technical effect of one or more of the example embodiments disclosed herein is a dispensing nozzle having a fluid dispersion element for dispensing viscous materials. More particularly, the arrangement and features of the dispensing nozzle and fluid dispersion element of the present disclosure provide for improved dispensing repeatability and accuracy of medium and high viscosity materials containing air bubbles. While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

1. A dispensing nozzle comprising:
a nozzle body having a hollow enclosure defining an inner chamber; and
a fluid dispersion element arranged within the inner chamber, the fluid dispersion element comprising a fluid inlet having at least two orifices that respectively open into and communicate with an associated fluid dispersion channel, wherein each fluid dispersion channel has a reduced cross section from that of the fluid inlet and is arranged to disperse a flow of materials received at the fluid inlet into parallel streams of flow prior to recombination of the materials at a nozzle outlet.

2. The dispensing nozzle of claim 1, wherein the fluid inlet is sized to receive a first stream of material flow, and wherein each fluid dispersion channel is sized to receive a second stream of material flow having a reduced cross section from that of the first stream of material flow to facilitate dispersion of air bubbles formed in each of the first and second streams.

3. The dispensing nozzle of claim 2, wherein each fluid dispersion channel comprises a first channel element and a second channel element, wherein at least one of the first or second channel elements comprises a generally arcuate configuration.

4. The dispensing nozzle of claim 3, wherein an end portion of the second channel element of a first fluid dispersion channel is arranged proximate an end portion of the second channel element of a second fluid dispersion channel so as to facilitate recombination of the dispersed streams of material flow.

5. The dispensing nozzle of claim 3, wherein a cross-section of each fluid dispersion channel is geometrically dimensioned based on a process variable.

6. The dispensing nozzle of claim 5, wherein each fluid dispersion channel comprises a generally triangular cross-section.

7. The dispensing nozzle of claim 1, wherein the nozzle body is formed using three-dimensional printing techniques.

8. The dispensing nozzle of claim 1, wherein the angular dimensions of the internal and external contours and surfaces of the nozzle body and fluid dispersion element are less than 90 degrees.

9. The dispensing nozzle of claim 1, wherein the nozzle body comprises a polymeric material.

10. The dispensing nozzle of claim 9, wherein the polymeric material comprises one or more of the following: polyamide, polyurethane, acrylonitrile-butadiene-styrene, polyetherimide, or combinations thereof.

11. A dispensing nozzle comprising:
a nozzle body having a hollow enclosure defining an inner chamber;
a fluid dispersion element arranged within the inner chamber, the fluid dispersion element comprising a fluid inlet having at least two orifices that respectively open into and communicate with an associated fluid dispersion channel, wherein each fluid dispersion channel has a reduced cross section from that of the fluid inlet and is arranged to disperse a flow of materials received at the fluid inlet into parallel streams of flow prior to recombination of the materials at a nozzle outlet; and
a cover pivotally coupled to the nozzle body and arranged to enclose an outer surface of a tip portion of the nozzle outlet.

12. The dispensing nozzle of claim 11, wherein the fluid inlet is sized to receive a first stream of material flow, and wherein each fluid dispersion channel is sized to receive a second stream of material flow having a reduced cross section from that of the first stream of material flow to facilitate dispersion of air bubbles formed in each of the first and second streams.

13. The dispensing nozzle of claim 11, wherein each fluid dispersion channel comprises a first channel element and a second channel element, wherein at least one of the first or second channel elements comprises a generally arcuate configuration, and wherein an end portion of the second channel element of a first fluid dispersion channel is arranged proximate an end portion of the second channel element of a second fluid dispersion channel so as to facilitate recombination of the dispersed streams of material flow.

14. The dispensing nozzle of claim 11, wherein movement of the cover is manually controlled by an operator.

15. The dispensing nozzle of claim 11, wherein movement of the cover is automatically controlled via a pneumatic actuation device.

16. A dispensing nozzle comprising:
a nozzle body having a hollow enclosure defining an inner chamber;
a fluid dispersion element arranged within the inner chamber, the fluid dispersion element comprising a fluid inlet having at least two orifices that respectively open into and communicate with an associated fluid dispersion channel, wherein each fluid dispersion channel has a reduced cross section from that of the fluid inlet and is arranged to disperse a flow of materials received at the fluid inlet into parallel streams of flow prior to recombination of the materials at a nozzle outlet; and
a valve sized for removal insertion into the fluid inlet and configured to provide increased flow control.

17. The dispensing nozzle of claim 16, wherein the valve comprise one or more of the following; an elastomeric valve, needle valve, poppet valve, or combinations thereof.

18. The dispensing nozzle of claim 16, wherein the fluid inlet is sized to receive a first stream of material flow, and wherein each fluid dispersion channel is sized to receive a second stream of material flow having a reduced cross section from that of the first stream of material flow to facilitate dispersion of air bubbles formed in each of the first and second streams.

19. The dispensing nozzle of claim 16, wherein each fluid dispersion channel comprises a first channel element and a second channel element, wherein at least one of the first or second channel elements comprises a generally arcuate configuration.

20. The dispensing nozzle of claim 16, wherein an end portion of the second element of a first fluid dispersion channel is arranged proximate an end portion of the second channel element of a second fluid dispersion channel so as to facilitate recombination of the dispersed streams of material flow.
